(19) United States
(12) Patent Application Publication
(10) Pub. No.: US 2022/0343320 A1
(43) Pub. Date: Oct. 27, 2022

(54) MANAGING CURRENCY-BASED TRANSACTIONS BACKED BY THE INTRINSIC VALUE OF PHYSICAL OBJECTS

(71) Applicant: MyMarkit Inc., Los Angeles, CA (US)

(72) Inventor: Nan ZHANG, Los Angeles, CA (US)

(21) Appl. No.: 17/644,839

(22) Filed: Dec. 17, 2021

Related U.S. Application Data
(60) Provisional application No. 63/180,384, filed on Apr. 27, 2021.

(51) Int. Cl. G06Q 20/36; G06K 19/07; G06K 7/10; G06Q 30/08

(52) U.S. Cl. CPC G06Q 20/3678; G06K 19/0723; G06K 7/10366; G06Q 30/08; G06Q 2220/00

(57) ABSTRACT

Disclosed herein are system, method, and computer program product embodiments for managing point-based transactions backed by the intrinsic value of physical objects. In some embodiments, a transaction ledger system may manage a point-based currency backed by transactions corresponding to the intrinsic value of a physical object. The transaction ledger system may use an appraisal process to estimate a point value for the physical object. The transaction ledger system may also use an authentication process to provide consumer confidence that the physical good is authentic. The transaction ledger system may also manage sensor tag serial codes, such as radio-frequency identification (RFID) serial codes, to quickly verify authenticity when the physical object is resold. When executing transactions, the transaction ledger system may record transaction and point exchange data on a centralized and immutable ledger to prevent malicious attackers from falsifying data.

### CROSS-REFERENCE TO RELATED APPLICATIONS

The present application claims priority to U.S. Provisional Patent Application 63/180,384, filed Apr. 27, 2021, which is incorporated herein in its entirety.

### BACKGROUND

### Field

This field is generally related to managing a transaction ledger system where currency-agnostic transactions are backed by the intrinsic value of physical objects.

### Related Art

Transactions for goods and physical items have evolved via the Internet. Consumers are now able to connect online as buyers and sellers. There are several issues, however, with these online transactions. For example, exchange issues arise when parties attempt to transact using different currencies. There is added overhead and transaction costs when executing this type of transaction. These transactions also raise other issues, however, related to the intrinsic value of the goods or physical items that are transacted. As commerce evolves, transactions continue to move away from trade or barter systems that were originally based on the intrinsic value of a good. Consumers are no longer transacting based on the value of the good, but are instead transacting based on prices that include overhead and other hidden costs.

Further, goods often lose value once they have been purchased for the first time. This negatively impacts consumers because they often resell the goods at a significant loss. While the intrinsic value of a product has not changed, the resale market price for such a product may be significantly less than the original purchase price. This may occur because resale buyers may be unable to verify the authenticity of the product. In this way, a consumer has lost market value for a brand new product even if there has been no change to the intrinsic value of that product.

### BRIEF SUMMARY

Disclosed herein are system, apparatus, device, method and/or computer program product embodiments, and/or combinations and sub-combinations thereof, for a transaction ledger system that operates to preserve the intrinsic value of a physical good. The transaction ledger system may utilize a currency that is backed by the intrinsic value of the physical good. Further, the transaction ledger system may utilize authentication processes to provide consumer confidence that the physical good is authentic. The transaction ledger system may also manage a ledger that is immutable and therefore provides confidence in tracking the transactions and intrinsic value of the physical good. In this way, the transaction ledger system may preserve the intrinsic value of the item and may facilitate trade while reducing unnecessary and wasteful transaction costs.

The embodiments disclosed herein may facilitate a currency-agnostic exchange of points backed by the intrinsic value of physical objects. In some embodiments, users may create user accounts with point wallets to participate in transactions managed by a transaction ledger system. Users may convert world currencies to these points to participate in transactions. The transaction ledger system may facilitate transactions based on the exchange of points for physical objects. In some embodiments, these physical objects may be luxury goods, such as clothing, jewelry, accessories, electronics, and/or other items where authenticity provides value for the physical object. In some embodiments, the physical objects may be retail commodities. By exchanging points, users may avoid the issue of transactions being limited by different user currencies.

Because the points are currency-agnostic, the intrinsic value of the physical object may be expressed in the points exchanged during the transaction. In this manner, the points themselves may be backed by transactions that have actually occurred. As will be further explained below, these point transactions may be tracked using an immutable centralized ledger. The centralized ledger may then confirm the intrinsic value of the item based on the points used to purchase the item. In this manner, the points may be backed by the intrinsic value of the physical goods that are exchanged. The points being the medium for exchange may thus better reflect the exchange of goods and may better encapsulate the intrinsic value of the item itself. These points may also reflect the intrinsic value of the goods without the added transaction overhead costs. For example, the points may be free from transaction costs and/or added hidden costs that are not tied to the intrinsic value of the physical object.

The transaction ledger system may track these points and transactions using an immutable centralized ledger. For example, the transaction ledger system may utilize a ledger similar to one used in blockchain technology to track transactions. In some embodiments, the ledger may be centralized rather that distributed. The ledger may still perform a block-based preservation of ledger entries. For example, the ledger may calculate one or more hashes based on previously saved transaction data. As additional transactions are executed and saved, hash values may continue to be calculated and/or updated by adding new transactions to previously saved transactions. In this manner, the ledger may be immutable and resistant to spoofing. Malicious entities will not be able to recreate the previously stored transactions in the previous blocks and will therefore be unable to generate verifiable hashes based on fake transactions. Using this centralized ledger, the transaction ledger system may provide added security and trust for managing the point-based transactions. The transaction ledger system may also preserve the intrinsic value of physical objects as they are sold and/or resold over time.

In some embodiments, the transaction ledger system may also provide trust using the centralized ledger by preserving the authenticity of physical objects. For example, the transaction ledger system may track an authentication and/or appraisal process for a physical object. When a user wishes to sell a physical object, administrators of the transaction ledger system may perform an authentication process to verify that the physical object is authentic to what the user purports it to be. When received for the first time, the physical object may be authenticated based on a physical examination of the product. For example, if the physical object is a luxury handbag, the physical examination may include a confirmation of the brand with distinct markings. The physical examination may confirm that the physical object is not a counterfeit. After this authentication, an administrator may provide credentials to the transaction ledger system to confirm authentication. This may include, for example, the credentials of the authorities performing the authentication and/or documentation proving authentication. With this information, the transaction ledger system may preserve and track the authentication of the physical object. This may additionally preserve the intrinsic value of the physical object. For example, confirmation that a handbag is genuine may preserve its intrinsic value.

In addition to this authentication, the transaction ledger system may also track a serial number to provide additional trust and to reduce transaction costs in the event that the physical object is resold. For example, in some embodiments, a sensor tag may be attached or affixed to the physical object once it has been authenticated. In some embodiments, the sensor tag may include a printed code, bar code, QR code, a near-field communication (NFC) tag, a passive tag, and/or an active tag. In some embodiments, the sensors tag may be a radio-frequency identification (RFID) tag. The RFID tag may be small and/or may have dimensions on the order of fractions of a millimeter and/or on the order of micrometers. The transaction ledger system may track a serial code identification (ID) corresponding to the RFID tag and associate this serial code ID with the physical object. By tracking this serial code ID, if a user wishes to resell a physical object that has already been tagged, an administrator of the transaction ledger system may scan the RFID tag to confirm that the physical object is authentic. Scanning the RFID tag may allow for the avoidance of a full authentication process. In this manner, by tracking the serial code ID, the transaction ledger system may reduce wasteful overhead costs associated with reselling the physical object. This process again helps to preserve the intrinsic value of the product by quickly verifying the authenticity. While the disclosure below may refer to an RFID tag, the processes described may be used with other sensor tags as well.

### BRIEF DESCRIPTION OF THE DRAWINGS

The accompanying drawings are incorporated herein and form a part of the specification.

FIG. 1 is a block diagram of a transaction management environment, according to some embodiments.

FIG. 2A is a flowchart illustrating a method for executing a first transaction, according to some embodiments.

FIG. 2B is a flowchart illustrating a method for executing a second transaction, according to some embodiments.

FIG. 3A is a flowchart illustrating a computer-implemented method for executing a first transaction, according to some embodiments.

FIG. 3B is a flowchart illustrating a computer-implemented method for executing a second transaction, according to some embodiments.

FIG. 4 is a diagram that illustrates a graphical user interface for inputting transaction information, according to some embodiments.

FIG. 5 is a diagram that illustrates a graphical user interface of a ledger dashboard, according to some embodiments.

FIG. 6 is a diagram that illustrates a graphical user interface for managing user account information, according to some embodiments.

FIG. 7 is a diagram that illustrates a graphical user interface for managing user transactions, according to some embodiments.

FIG. 8 is a diagram that illustrates a graphical user interface for managing a user point balance, according to some embodiments.

FIG. 9 is a diagram that illustrates a graphical user interface for browsing listed products, according to some embodiments.

FIG. 10 is a diagram that illustrates a graphical user interface for confirming membership transaction details, according to some embodiments.

FIG. 11 is a diagram that illustrates a graphical user interface for confirming a transaction, according to some embodiments.

FIG. 12 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing point-based transactions backed by the intrinsic value of physical objects. Various embodiments of these features will now be discussed with respect to the corresponding figures.

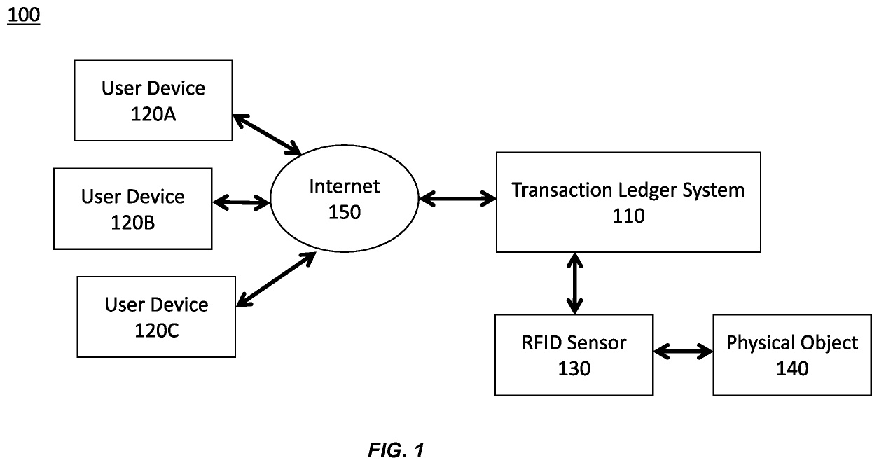

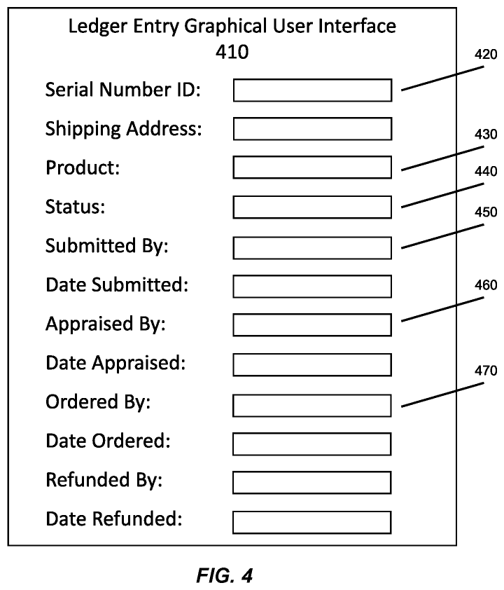

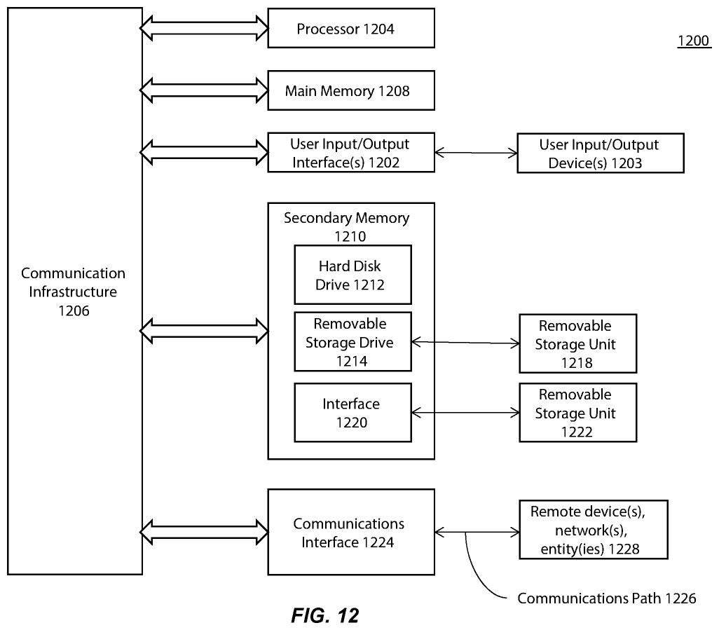

FIG. 1 is a block diagram of a transaction management environment 100, according to some embodiments. Transaction management environment 100 may include transaction ledger system 110, user devices 120A, 120B, 120C, radio-frequency identification (RFID) sensor 130, physical object 140, and/or Internet 150. Transaction ledger system 110 and/or user devices 120 may be implemented using computer system 1200 as will be further described with reference to FIG. 12. As will be further explained below, transaction ledger system 110 may facilitate the listing and/or sale of physical object 140. In some embodiments, physical object 140 may be a luxury good, such as an article of clothing, a piece of jewelry, an accessory, a wearable accessory, an electronic device, and/or another item where authenticity provides value for physical object 140. To facilitate transaction of physical object 140, transaction ledger system 110 may facilitate the exchange of currency-agnostic points as well as manage a centralized ledger of transactions and data corresponding to physical object 140. Transaction ledger system 110 may also manage websites, dashboards, and/or graphical user interfaces (GUIs) that may be displayed on user devices 120 to participate in the transaction of physical object 140. Examples of the GUIs will be further described with reference to FIGS. 4 through 11.

In some embodiments, the transaction ledger system 110 may manage user accounts and/or point values corresponding to user accounts. Transaction ledger system 110 may also track the transactions corresponding to the account and/or a number of transactions corresponding to an account membership. When a user wishes to sell physical object 140, transaction ledger system 110 may generate a webpage listing. As will be further explained below, transaction ledger system 110 may also facilitate an appraisal process to determine an estimated point value for physical object 140. Upon generating the listing, a buyer may access the listing via transaction ledger system 110 to purchase physical object 140. The seller may then deliver physical object 140 to an administrator of transaction ledger system 110. The administrator may then perform an authentication process and update a centralized ledger managed by transaction ledger system 110 of the authentication. In some embodiments, the administrator may attach and/or affix an RFID tag to physical object 140. This RFID tag may aid in the future authentication of physical object 140. In some embodiments, a different sensor tag such as a printed code, bar code, QR code, a near-field communication (NFC) tag, a passive tag, and/or an active tag may used instead of an RFID tag. The administrator may then ship physical object 140 to the buyer and update the central ledger using transaction ledger system 110 to manage the status of the transaction. Transaction ledger system 110 may then deduct points from the buyer's wallet and add the points to the seller's wallet to facilitate the transaction.

As previously explained, this management of points as well as authenticity data may facilitate currency-agnostic transactions as well as provide trust for the transaction. Transaction ledger system 110 may then back the points managed using the intrinsic value of physical object 140. This process may be scaled to many physical objects 140, which may then provide backing to the managed points via multiple transactions based on intrinsic value. Further, tracking the points as well as RFID tags may aid in reducing overhead and/or transaction costs in the event that physical object 140 is resold.

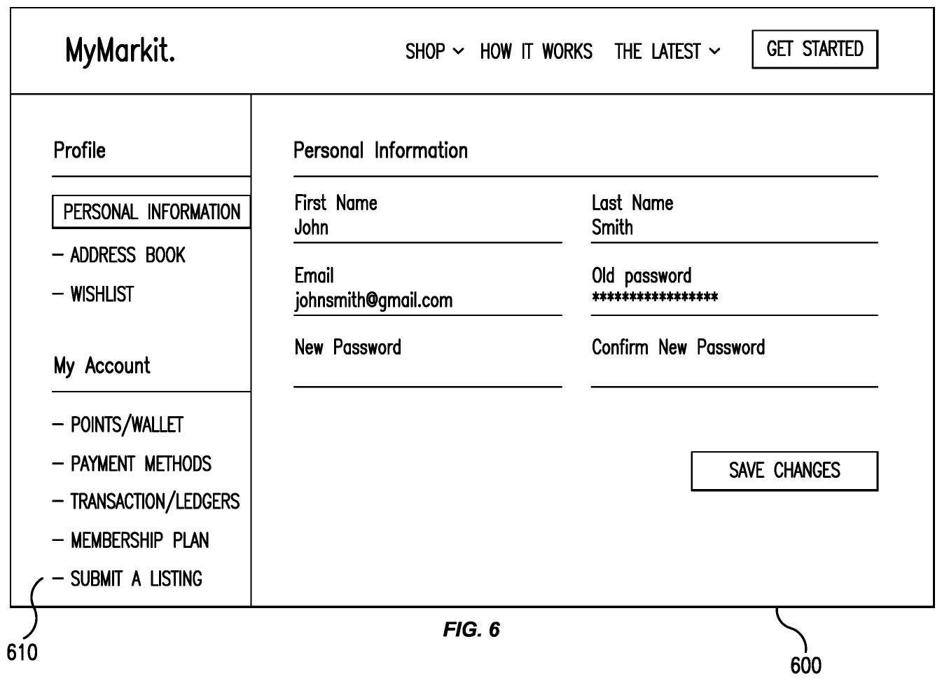

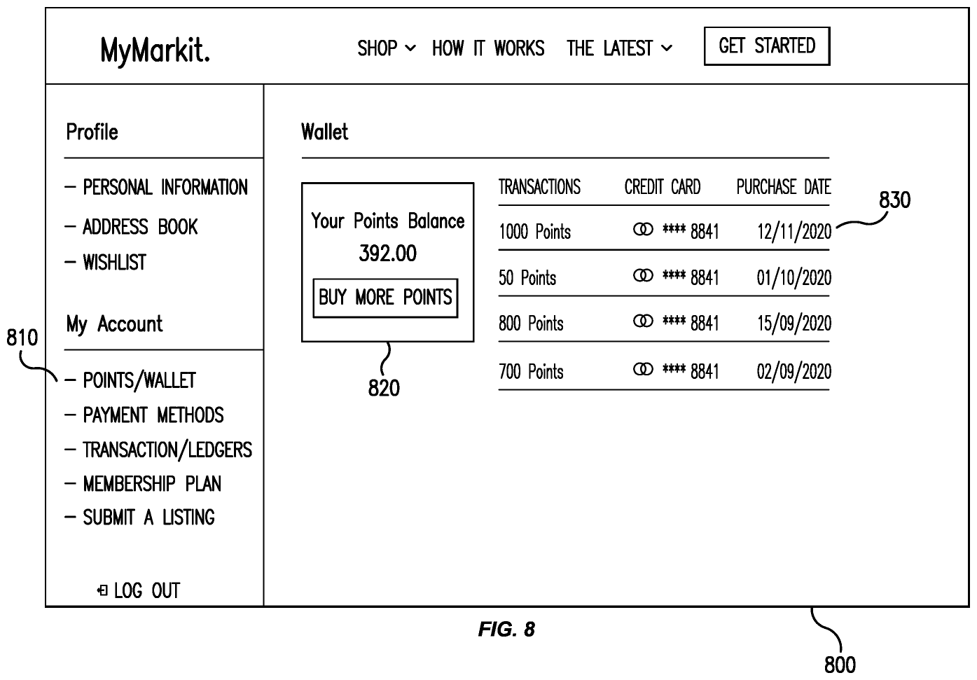

Regarding account management, transaction ledger system 110 may manage user accounts. Users may interact with transaction ledger system 110 and manage corresponding accounts using a user device 120. These user accounts may have corresponding wallets and/or point values. Users may acquire points via a purchase of points and/or via a sale of physical object 140. As will be further explained below, FIG. 6 provides an example GUI displaying a user account screen. FIG. 8 provides an example GUI depicting a point balance.

In some embodiments, transaction ledger system 110 may track membership information corresponding to a user account. Membership information may control the number of transactions a user is able to participate in. In some embodiments, membership may have different tiers corresponding to a number of allowed transactions. Membership may be a monthly fee corresponding to a number of monthly transaction. For example, for a fee of $30 per month, a user may be allowed to participate in six transactions. In some embodiments, a user may purchase additional transactions. These may be transactions as either the buyer or the seller of physical object 140. In some embodiments, a transaction may be deducted when the user is a seller or a buyer. In some embodiments, a transaction may be deducted only when the user is a seller. In some embodiments, a transaction may be deducted only when the user is a buyer. For example, transaction ledger system 110 may manage a total number of transactions for a buyer account and deduct a transaction from the total number when deducting a transacted point value from the buyer's point wallet.

By tracking membership and transactions separately from the points used to conduct the transaction of physical object 140, transaction ledger system 110 may more accurately preserve the intrinsic value of physical object 140. For example, rather than adding overhead costs to the transaction of physical object 140, any associated transaction costs may be covered via the membership process and the deduction of allowed transactions. In this manner, transaction ledger system 110 may execute the transaction for buyers and sellers as an exchange of points corresponding to the intrinsic value of physical object 140.

When a user wishes to sell physical object 140, transaction ledger system 110 may aid the user in creating a webpage listing. The seller may use user device 120A to access transaction ledger system 110 via Internet 150. For example, the seller may access a webpage displaying a GUI as depicted in FIG. 6. Transaction ledger system 110 may generate this GUI as displayed on user device 120A. The seller may then choose to submit a listing by interacting with a GUI object, such as a button or a link. Upon selecting this GUI object, transaction ledger system 110 may request additional information from the user about physical object 140. In some embodiments, transaction ledger system 110 may generate a fillable form for the user to enter information using user device 120A. In some embodiments, transaction ledger system 110 may request information such as a product description of physical object 140, brand information, quality or condition information, any authentication information (e.g., certifications of authenticity, appraisal documents), images of physical object 140, and/or other data related to physical object 140.

Upon receiving the request data, transaction ledger system 110 may generate a webpage listing physical object 140 for sale. In some embodiments, transaction ledger system 110 may perform a process of estimating a point value to include on the webpage listing. This process may include scraping data from Internet 150 related to estimated prices corresponding to physical object 140. For example, transaction ledger system 110 may use a web scraper or crawler to identify data from webpages listing physical object 140 for sale. In some embodiments, the web scraper or crawler may be configured to generally target websites selling goods or items. In some embodiments, the web scraper or crawler may be configured to target specific websites selling physical object 140 and/or similar objects.

Based on an aggregation of pricing data, transaction ledger system 110 may calculate an average price corresponding to physical object 140. This average may weigh the condition of physical object 140 as well based on the information gathered from the different webpages. The average may weigh the aggregated price data based on the condition listed on the different webpages. Transaction ledger system 110 may also perform a price conversion from the different webpages so that the calculation may be uniform. In some embodiments, transaction ledger system 110 may convert the aggregated prices into points and determine an average based on points. This conversion may be a similar conversion performed when a user purchases points using a monetary currency. Transaction ledger system 110 may include this average price information on the webpage for the generated listing.

In some embodiments, transaction ledger system 110 may provide a range of point values based on the aggregated pricing data. This range of point values may indicate a lower and/or upper boundary based on the identified prices from Internet 150. In some embodiments, the range may be a plus or minus percentage of the determined average price. In some embodiments, the range may be based on the condition of physical object 140 as identified on the Internet 150. For example, an upper bound of the range may reflect a new or nearly new condition of physical object 140. A lower bound of the range may reflect a more used condition.

Transaction ledger system 110 may record an average and/or range of point values determined via the web scraping on the centralized ledger. In some embodiments, transaction ledger system 110 may record a timestamp and/or source information used to generated the estimated point value and/or range of point values. The source information may include the webpages identified and/or the values identified from those webpages.

In some embodiments, an appraiser may view the submitted information and provide an estimated point value. For example, transaction ledger system 110 may send the submitted information to an appraiser via email and/or via a dashboard notification accessible to the appraiser to view the submitted information. The appraiser may then provide an estimated point value based on the appraiser's evaluation. In some embodiments, this value may be a range of point values. Transaction ledger system 110 may record the estimated point value on the centralized ledger. Transaction ledger system 110 may also record a timestamp corresponding to the submitted appraisal and/or the appraiser's credentials to record identifying information of the appraiser. For example, transaction ledger system 110 may record a name, a username, and/or contact information corresponding to the appraiser. In some embodiments, the appraiser may be an expert appraiser.

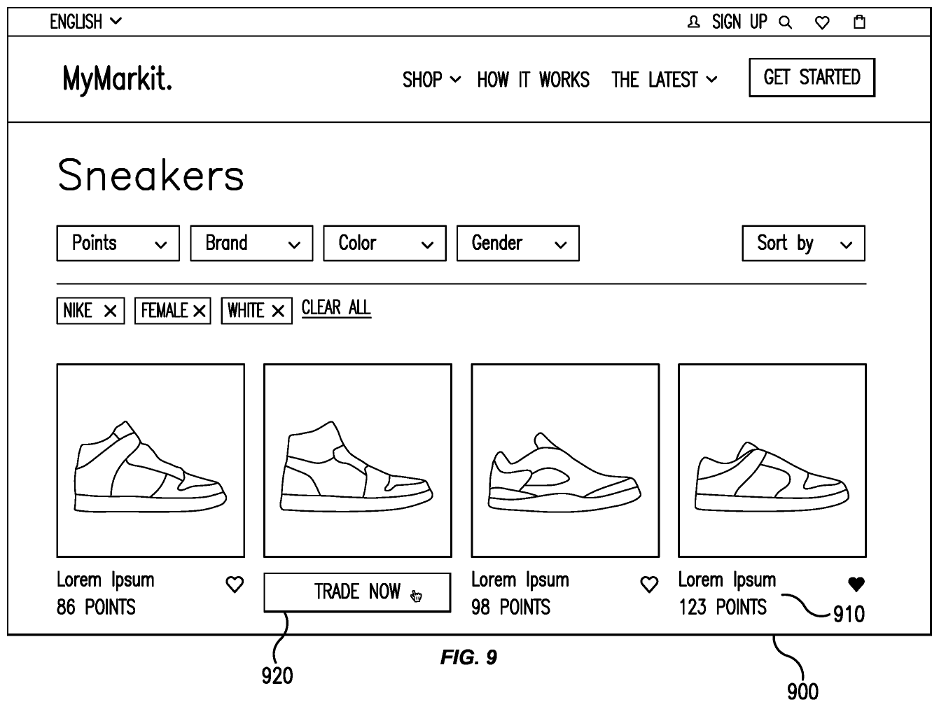

Using an estimated point value, transaction ledger system 110 may include this value on the webpage listing physical object 140 for sale. Potential buyers using, for example, user device 120B may view the webpage listing as managed by transaction ledger system 110. An example of a GUI displaying listings is further described below with reference to FIG. 9. Using user device 120B, a buyer may place a request to purchase physical object 140. In some embodiments, the request may be for the point value listed on the webpage listing. The buyer may select a purchase button on the GUI to proceed with a purchase. If the point value listed on the webpage listing is a range of values, the request may include a point value within the range. In some embodiments, a value within the range may be accepted by transaction ledger system 110 as completion of the purchase. In some embodiments, transaction ledger system 110 may receive this request and generate a notification to the seller via an email and/or a notification on a dashboard of the value. The seller may then accept the specified point value to acknowledge the purchase.

In some embodiments, transaction ledger system 110 may perform a bidding process to facilitate the purchase of physical object 140. For example, multiple buyers may submit purchase offers with different point values. Transaction ledger system 110 may identify the highest bidder based on point value to purchase physical object 140. In some embodiments, the bidding may be timed and may be designated to end at a certain point. Potential buyers may submit point value bids within this time window. These point value bids may extend beyond a calculated average point value and/or an upper bound of a range identified by transaction ledger system 110. In some embodiments, transaction ledger system 110 may record on the centralized ledger the bids submitted with corresponding user information and/or the winning bid with user information.

Upon identifying a purchaser either through a purchase process and/or a bidding process, transaction ledger system 110 may facilitate an authentication of physical object 140. The seller may mail, deliver, and/or ship physical object 140 to an administrator of transaction ledger system 110. The administrator may then inspect and/or authenticate physical object 140 to confirm authenticity. This process may include authenticating the data provided by the seller when generating the listing. Transaction ledger system 110 may generate a dashboard GUI with an authentication field for indicating authentication of physical object 140. An example of such a GUI will be further described with reference to FIG. 4. After authenticating physical object 140, the administrator may use the GUI to provide an indication to transaction ledger system 110 that the authentication has been completed. Transaction ledger system 110 may then record this authentication in the centralized ledger. In some embodiments, transaction ledger system 110 may record a corresponding timestamp and/or user credentials or information corresponding to the administrator that performed the authentication.

In some embodiments, if the administrator determines that physical object 140 is not authentic, transaction ledger system 110 may record this failure on the centralized ledger. The administrator may then ship physical object 140 back to the seller.

If physical object 140 has been successfully authenticated, the administrator may attach and/or affix an RFID tag to physical object 140. The RFID tag may be small and/or may have dimensions on the order of fractions of a millimeter and/or on the order of micrometers. The RFID tag may be a passive tag. In some embodiments, the RFID tag may be preprogrammed with a serial code ID. Using RFID sensor 130, transaction ledger system 110 may scan the RFID tag attached to physical object 140 to read the serial code ID. Transaction ledger system 110 may then store the identified serial code ID on the centralized ledger. Transaction ledger system 110 may associate the serial code ID with physical object 140 on the centralized ledger. Associating the serial code ID with physical object 140 may aid in reducing overhead and transaction costs in the event that physical object 140 is resold. In this case, administrators may avoid re-appraising and/or re-authenticating physical object 140 because administrators will be able to scan the RFID tag using RFID sensor 130. Transaction ledger system 110 may then confirm that a scanned serial code ID matches the serial code ID that is stored on the immutable centralized ledger. This scan may provide faster confirmation that physical object 140 is authentic. Further, using a smaller sized RFID tag may avoid user tampering because a user will be unable to locate the RFID tag as affixed to physical object 140.

In some embodiments, the RFID tag may not be preprogrammed with a serial code ID. In this case, transaction ledger system 110 may assign a serial code ID to the RFID tag. RFID sensor 130 may burn this serial code ID into the RFID tag. Transaction ledger system 110 may record the assigned serial code ID on the centralized ledger. In some embodiments, a different sensor tag such as a printed code, bar code, QR code, a near-field communication (NFC) tag, a passive tag, and/or an active tag may used instead of an RFID tag. The processes of scanning and authenticating the sensor tag may be performed in a similar manner.

Either before or after recording the serial code ID on the centralized ledger, transaction ledger system 110 may perform the process of transferring points from the buyer's digital wallet to the seller's digital wallet. For example, transaction ledger system 110 may deduct a transacted point value from the buyer's digital wallet. Transaction ledger system 110 may add the transacted point value to the seller's digital wallet. This transacted point value may be backed by the actual transaction and the intrinsic value of physical object 140. Transaction ledger system 110 may update the centralized ledger to record this transaction and/or the transacted point value. This update may be associated with physical object 140 to link the point value to physical object 140.

Transaction ledger system 110 may also associate the physical object to the buyer's account and disassociate the physical object from the seller's account. Transaction ledger system 110 may track these associations using the centralized ledger. In some embodiments, a data structure corresponding to the physical object 140 may be updated to reflect ownership of physical object 140. In some embodiments, user account information may be updated and tracked using the centralized ledger to reflect the updated ownership.

In addition to using transaction ledger system 110 to manage the transaction of points, an administrator of transaction ledger system 110 may use the information from transaction ledger system 110 to facilitate the shipping and/or delivery of physical object 140 to the buyer. For example, after authenticating physical object 140, the administrator may use transaction ledger system 110 to generate a shipping label for sending physical object 140 to the buyer's indicated address. The administrator may also package the physical object 140 based on the brand and/or product information provided by transaction ledger system 110. For example, the administrator may include brand specific certifications and/or marketing materials based on the data tracked on the centralized ledger. Upon shipping physical object 140, the administrator may update transaction ledger system 110. Transaction ledger system 110 may track statuses such as the shipping date and/or the estimated arrival date of the physical object 140. In some embodiments, transaction ledger system 110 may track returns of physical object 140 if the buyer refuses to accept the item. In this case, transaction ledger system 110 may also refund points to the buyer and deduct points from the seller. To avoid this situation, transaction ledger system 110 may use an escrow system to hold onto points until the buyer has accepted physical object 140. When this occurs, transaction ledger system 110 may release the points in escrow to the seller's point wallet. This may complete the transfer of physical object 140 from the seller to the buyer.

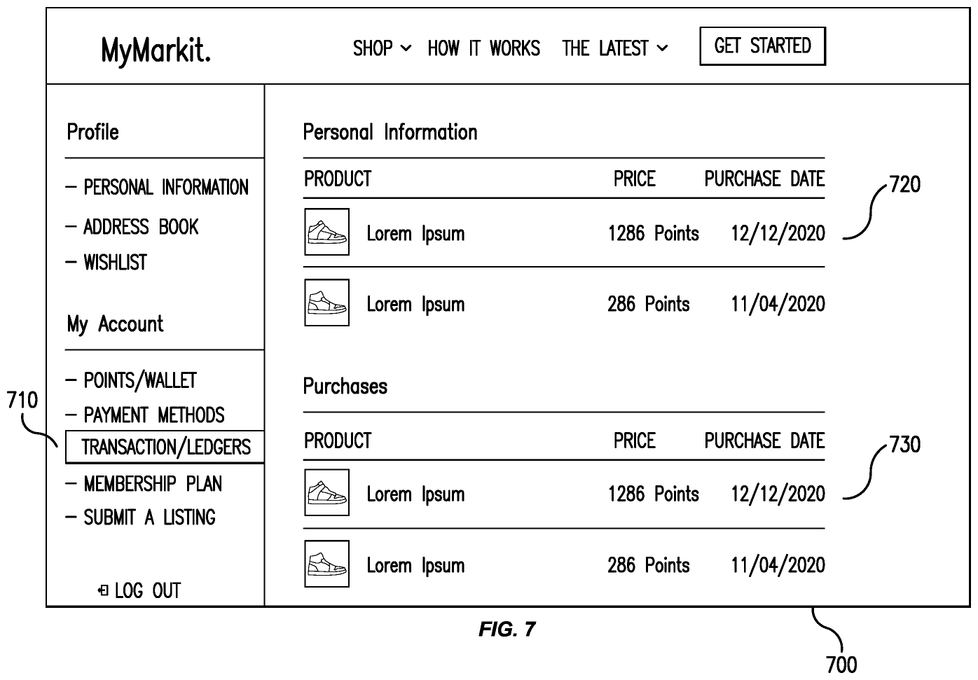

In some embodiments, transaction ledger system 110 may facilitate the re-sale of physical object 140. For example, after a user has purchased and received physical object 140, the user may wish to resell physical object 140 to another user. In this case, the user may access an account GUI and select a button or link indicating a resale of physical object 140. In some embodiments, transaction ledger system 110 may display an indication of the previous transaction. For example, transaction ledger system 110 may display the previous transaction in a manner similar to the GUI described with reference to FIG. 7. The user may select the previous purchase and indicate a desire to resell the same physical objet 140. In some embodiments, the user may submit a listing for the physical object 140 and/or may provide additional descriptive data. This data may identify physical object 140 and/or may provide data related to the condition of physical object 140.

Transaction ledger system 110 may generate another webpage listing the sale of physical object 140. This webpage may be similar to the previously created webpage for physical object 140. In some embodiments, the webpage may be the same as the previously created webpage. In some embodiments, transaction ledger system 110 may modify elements of the webpage. For example, transaction ledger system 110 may update the points value for physical object 140 to reflect the actual transacted point value of the previous transaction. Transaction ledger system 110 may update the point value in other ways, such as based on the updated condition of physical object 140. Similarly, transaction ledger system 110 may update information related to the condition of physical object 140. Transaction ledger system 110 may also update the centralized ledger to indicate that the physical object 140 has been listed again for sale.

Another buyer may then identify the webpage listing and submit a request to purchase physical object 140. This may occur in a manner similar to the previous sale of physical object 140. The new buyer may provide the requested point price or may provide a different point value for the purchase. After completing the purchase, transaction ledger system 110 may notify the user that is reselling physical object 140 that a sale has been made. The user may then ship and/or deliver physical object 140 to an administrator of transaction ledger system 110.

Using RFID sensor 130, transaction ledger system 110 may scan the RFID tag affixed to physical object 140. Transaction ledger system 110 may identify a scanned serial code ID corresponding to the RFID tag. In some embodiments, a different sensor tag such as a printed code, bar code, QR code, a near-field communication (NFC) tag, a passive tag, and/or an active tag may used instead of an RFID tag. A sensor corresponding to this tag may replace RFID sensor 130 and may be used to scan the serial code ID corresponding to the sensor tag used. Transaction ledger system 110 may then identify a previously stored serial code from the centralized ledger that corresponds to physical object 140. Transaction ledger system 110 may determine that the scanned serial code ID matches the one stored on the centralized ledger. In this case, transaction ledger system 110 may verify physical object 140 as authentic. Transaction ledger system 110 may update the centralized ledger to indicate this authentication. For example, transaction ledger system 110 may provide an updated status and/or timestamp corresponding to the authentication.

In some embodiments, if transaction ledger system 110 determines that the scanned serial code ID does not match the serial code ID stored on the centralized ledger, transaction ledger system 110 may determine that the received item is not authentically the previous physical object 140. Transaction ledger system 110 may record this failure on the centralized ledger. The administrator may then ship physical object 140 back to the user.

If transaction ledger system 110 determines that the physical object 140 is authentic based on a scan of the RFID tag or sensor tag, transaction ledger system 110 may exchange point values for the transaction. Transaction ledger system 110 may deduct the transacted point value from the new owner of physical object 140. Transaction ledger system 110 may add this transacted point value to the previous owner. Transaction ledger system 110 may then update the centralized ledger to include the associated ownership information. Transaction ledger system 110 may also update the centralized ledger to record the second transacted point value. This may update the intrinsic value of physical object 140 when it has been resold.

In some embodiments, transaction ledger system 110 may include a cash out process. This cash out process may allow users to convert points to monetary currency. In some embodiments, this conversion may correspond to the conversion from a monetary currency to points. If a user requests a cash out, transaction ledger system 110 may notify an administrator and/or begin a check writing process to mail to the user. In some embodiments, transaction ledger system 110 may convert the points to a cryptocurrency to deposit in a digital cryptocurrency wallet corresponding to the user.

In some embodiments, the points may be considered a currency itself backed by the commodities managed by transaction ledger system 110. Because they are backed by commodities and optionally pegged to a country currency, they may be less volatile than other currencies, including well-known crypto currencies. Their value comes not just from the belief that others will accept points for exchange, but also from their association with the underlying commodity. Acting as a currency, the points may be used to purchase and transact all manner of goods and services. Digital banking services may be provided for the points. They may act as a store of wealth and may be used to transact value. In addition, they can be used to invest in securities, and may even accrue interest.

In some embodiments, transaction ledger system 110 may facilitate the purchase of points. A user may purchase points using a country-based currency, a digital currency, and/or a cryptocurrency. For example, a user may purchase points using Bitcoin or other digital currency. In some embodiments, transaction ledger system 110 may facilitate a conversion of a non-fungible token (NFT) into points. Transaction ledger system 110 may facilitate point conversion transactions and/or use a third-party system to execute the conversion to points. Transaction ledger system 110 may facilitate points as still being backed by the commodities exchanged using transaction ledger system 110. In this manner, transaction ledger system 110 may provide a gateway for digital currencies to real world goods.

Based on the point currency, transaction ledger system 110 may facilitate the conversion of points into different country currencies. In some embodiments, transaction ledger system 110 may operate as a payment gateway or payment portal. In this manner, transaction ledger system 110 may be used for digital banking management. The points managed by transaction ledger system 110 may be considered the currency managed for these banking operations. Transaction ledger system 110 may track transactions and/or banking operations using its ledger system for managing point currency. Transaction ledger system 110 may manage points, digital currency, and/or country-based currency in escrow. As previously explained, the points managed by transaction ledger system 110 may be backed by the commodities managed by transaction ledger system 110. This currency may be backed by the intrinsic value of physical goods. Transaction ledger system 110 may then operate as a gateway for converting digital currency into tangible and/or real-world goods or products.

As previously explained, transaction ledger system 110 may also facilitate lossless transaction to avoid tying overhead costs to transactions. With digital currencies, transaction ledger system 110 may aid users in preserving the value of their points when conducting a transaction.

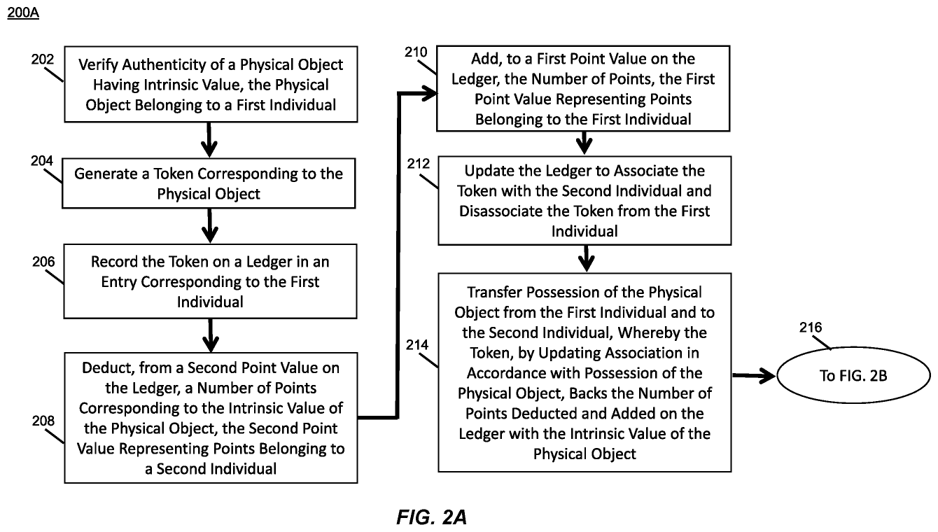

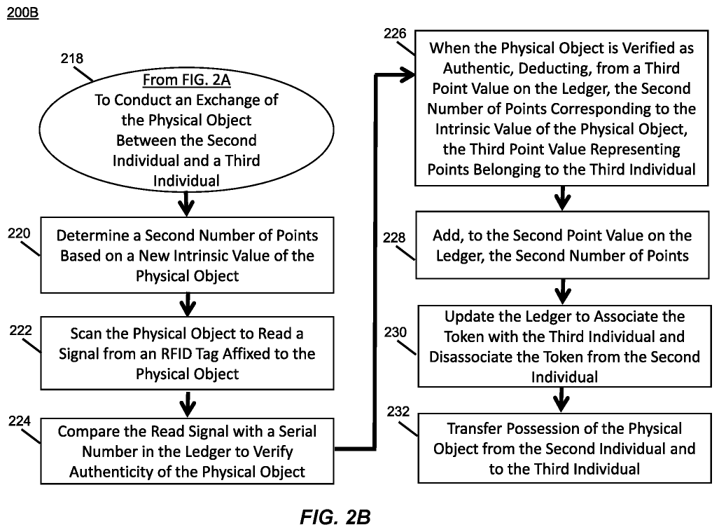

FIG. 2A is a flowchart illustrating a method 200A for executing a first transaction, according to some embodiments. Method 200A shall be described with reference to FIG. 1; however, method 200A is not limited to that example embodiment.

In an embodiment, a transaction ledger system 110 may be used by an administrator to aid with facilitating and/or executing a transaction between a first individual and a second individual. Method 200A describes a process for using transaction ledger system 110 to execute this transaction and to manage the transaction on a centralized ledger. By using transaction ledger system 110 in this way, point values may be managed and/or backed by the intrinsic value of physical object 140. While method 200A is described with reference to transaction ledger system 110, method 200A may be executed using any computing device, such as, for example, the computer system described with reference to FIG. 12 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2A, as will be understood by a person of ordinary skill in the art.

At 202, an administrator of transaction ledger system 110 may verify authenticity of a physical object 140 having intrinsic value. The physical object 140 may belong to a first individual. To verify the authenticity, the administrator may examine physical object 140 and confirm that it matches a product description provided by a seller of physical object 140. For example, the administrator may perform a visual examination of physical object 140. The administrator may also review serial codes and/or documentation related to authenticity. This may include certificates of authentication. In some embodiments, the administrator may perform tests to verify authenticity. For example, the administrator may test the materials used in the physical object 140. If physical object 140 is an electronic device, the administrator may confirm operation of the physical object 140. Upon verifying the authenticity, the administrator may user transaction ledger system 110 to track statuses and data corresponding to physical object 140.

In some embodiments, after verifying the authenticity of physical object 140, the administrator may affix an RFID tag or other sensor tag to physical object 140. Transaction ledger system 110 may then record and/or track a corresponding serial number. This serial number may be used in later transactions to verify the authenticity of physical object 140.

At 204, transaction ledger system 110 may generate a token corresponding to physical object 140. A token may be data structure representing physical object 140. Transaction ledger system 110 may use a tokenization process to generate a string of characters referred to as a token. In some embodiments, the token may be hash value that is encrypted. Data corresponding to the token may similarly be hashed and/or encrypted when stored on the centralized ledger.

At 206, transaction ledger system 110 may record the token on a ledger in an entry corresponding to the first individual. Recording the token with this information preserve the association of physical object 140 to the first individual. In some embodiments, identifying information such as a name or contact information for the first individual may be recorded and associated with the token. In some embodiments, recording the token on the ledger may be performed using blockchain technology. The entry may be hashed based on previous entries in the ledger. In this way, the ledger may build a chain of entries where each entry is linked to previous entries based on a hash. With this linking, the ledger may be immutable and resistant to spoofing or false transactions. Malicious users will be unable to recreated each of the transactions and/or data recorded in the previous entries to generate a matching hash.

At 208, transaction ledger system 110 may deduct from a second point value on the ledger, a number of points corresponding to the intrinsic value of the physical object. The second point value may represent points belonging to a second individual. This deduction of points may occur in response to the second individual indicating a desire to purchase physical object 140. The number of points may be the value presented by the second individual for purchasing physical object 140. Transaction ledger system 110 may record this point value on the ledger to record the transaction.

At 210, transaction ledger system 110 may add, to a first point value on the ledger, the number of points. The first point value may represent points belonging to the first individual. This addition may represent the completion of the transaction and depositing the transacted point value in the seller's digital wallet. Transaction ledger system 110 may update the ledger to reflect this addition of points.

At 212, transaction ledger system 110 may update the ledger to associate the token with the second individual and disassociate the token from the first individual. In some embodiments, transaction ledger system 110 may add the information to the ledger and recalculate a hash based on the updated information.

At 214, an administrator of transaction ledger system 110 may transfer possession of physical object 140 from the first individual and to the second individual. In this manner, the token, by updating association in accordance with possession of the physical object 140, backs the number of points deducted and added on the ledger with the intrinsic value of the physical object 140. As previously explained, this transfer of possession may include shipping physical object 140 to the second individual. Transaction ledger system 110 may continue to manage the point balances for both individuals. By virtue of using transaction ledger system 110 to execute the transaction, the points transferred may be backed by the intrinsic value of physical object 140.

At 216, method 200A may continue to method 200B to conduct a subsequent transaction.

FIG. 2B is a flowchart illustrating a method 200B for executing a second transaction, according to some embodiments. Method 200B shall be described with reference to FIG. 1; however, method 200B is not limited to that example embodiment.

In an embodiment, a transaction ledger system 110 may be used by an administrator to aid with facilitating and/or executing a transaction between the second individual and a third individual. Method 200B describes a process for using transaction ledger system 110 to execute this transaction and to manage the transaction on a centralized ledger. By using transaction ledger system 110 in this way, point values may be managed and/or backed by the intrinsic value of physical object 140. While method 200B is described with reference to transaction ledger system 110, method 200B may be executed using any computing device, such as, for example, the computer system described with reference to FIG. 12 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2B, as will be understood by a person of ordinary skill in the art. While FIG. 2B may be described with reference to an RFID tag, other sensor tags may also be used in a similar manner.

At 218, transaction ledger system 110 may be used to conduct an exchange of the physical object 140 between the second individual and a third individual. To execute method 200B, an RFID tag may have been affixed to the physical object 140 when executing method 200A. For example, after an administrator of transaction ledger system 110 verifies the authenticity of physical object 140, the administrator of transaction ledger system 110 may affix an RFID tag to physical object 140.

At 220, transaction ledger system 110 may determine a second number of points based on a new intrinsic value of physical object 140. This second number of points may be provided by the third individual seeking to purchase physical object 140 from the second individual.

At 222, transaction ledger system 110 may scan physical object 140 to read a signal from the RFID tag affixed to physical object 140. Transaction ledger system 110 may perform this scan using RFID sensor 130. At 224, transaction ledger system 110 may compare the read signal with a serial number in the ledger to verify authenticity of the physical object 140. This comparison may include extracting a serial code identified from the signal and comparing the serial code with the serial code stored on the ledger. At 226, when physical object 140 is verified as authentic, transaction ledger system 110 may deduct from a third point value on the ledger, the second number of points corresponding to the intrinsic value of the physical object. The third point value may represent points belonging to the third individual.

At 228, transaction ledger system 110 may add, to the second point value on the ledger, the second number of points. This may indicate the transfer of points to the second user. At 230, transaction ledger system 110 may update the ledger to associate the token with the third individual and disassociate the token from the second individual. At 232, an administrator of transaction ledger system 110 may transfer possession of the physical object from the second individual to the third individual. The processes of deducting, adding, updating, and transferring may be performed similar to the processes described with reference to FIGS. 1 and 2A.

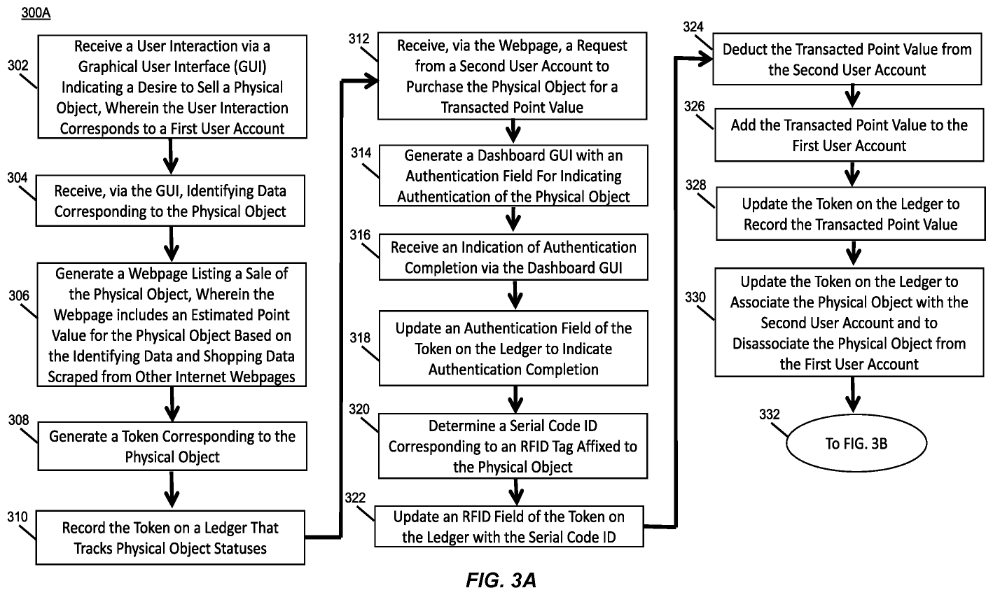

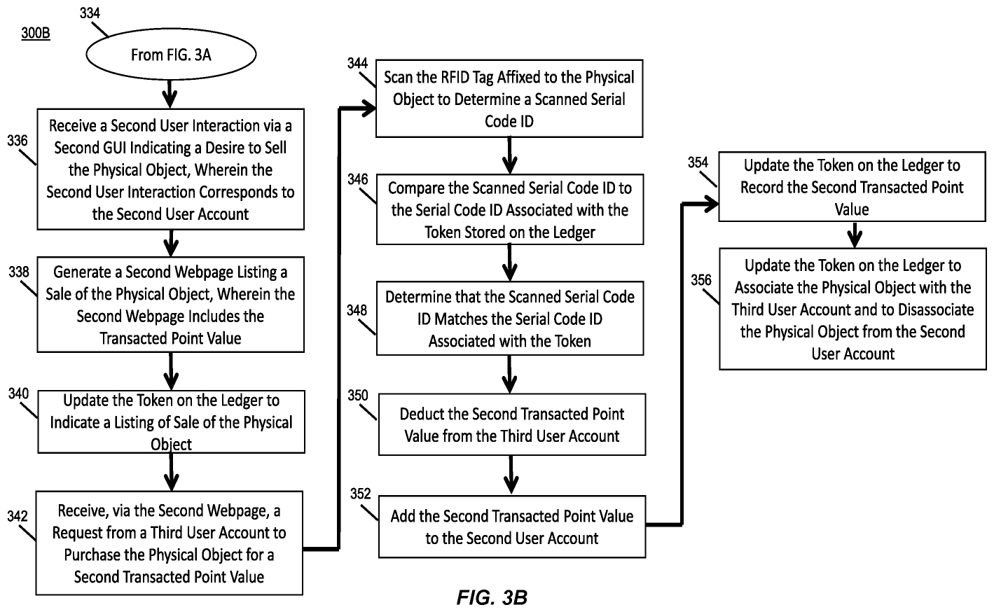

FIG. 3A is a flowchart illustrating a computer-implemented method 300A for executing a first transaction, according to some embodiments. Method 300A shall be described with reference to FIG. 1; however, method 300A is not limited to that example embodiment.

In an embodiment, a transaction ledger system 110 may execute method 300A to facilitate a transaction between a first user account and a second user account. Method 300A describes a process for using transaction ledger system 110 to manage the transaction on a centralized ledger. In this way, transaction ledger system 110 may manage point values that are backed by the intrinsic value of physical object 140. While method 300A is described with reference to transaction ledger system 110, method 300A may be executed using any computing device, such as, for example, the computer system described with reference to FIG. 12 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art. While FIG. 3A may be described with reference to an RFID tag, other sensor tags may also be used in a similar manner.

At 302, transaction ledger system 110 may receive a user interaction via a graphical user interface (GUI) indicating a desire to sell a physical object 140. The user interaction may correspond to a first user account. An example of this GUI is depicted in FIG. 6 as GUI 600. The user may view GUI 600 using a user device 120A that accesses transaction ledger system 110 via Internet 150. The user interaction may be a selection of a button 610 indicating that the user wishes to submit a listing. By selecting button 610, user device 120A may transmit data to transaction ledger system 110 to indicate that the user wishes to sell physical object 140.

At 304, transaction ledger system 110 may receive, via the GUI, identifying data corresponding to the physical object 140. For example, transaction ledger system 110 may generate a fillable form for the user to supply a product description, brand information, quality or condition information, images of physical object 140, and/or authentication data corresponding to physical object 140. This authentication data may be a serial number and/or images of certificates of authenticity.

At 306, transaction ledger system 110 may generate a webpage listing a sale of physical object 140. The webpage may include an estimated point value for physical object 140 based on the identifying data provide and shopping data scraped from other Internet 150 webpages. As described with reference to FIG. 1, transaction ledger system 110 may scrape and/or crawl webpages to identify an estimated point value. In some embodiments, this estimated point value may be a range of values. In some embodiments, the estimated point value may be generated based on an expert appraisal. As will be further explained with reference to FIG. 9, the generated webpage may be linked to a search result based GUI 900 so that potential buyers may find the webpage.

At 308, transaction ledger system 110 may generate a token corresponding to physical object 140. A token may be data structure representing physical object 140. Transaction ledger system 110 may use a tokenization process to generate a string of characters referred to as a token. In some embodiments, the token may be hash value that is encrypted. Data corresponding to the token may similarly be hashed and/or encrypted when stored on the centralized ledger. At 310, transaction ledger system 110 may record the token a ledger that tracks physical object statuses. The ledger may track status such as whether physical objects 140 have been listed for sale, appraised, authenticated, received from a seller, shipped to a buyer, and/or point values corresponding to transactions. The ledger may use a hash system and/or a block-based chain of hash values to record data. This may provide immutability as previously explained.

At 312, transaction ledger system 110 may receive, via the webpage, a request from a second user account to purchase the physical object 140 for a transacted point value. The transacted point value may be the same as the estimated point value and/or may be different. The user may agree to purchase physical object 140 for the estimated point value listed on the webpage. In some embodiments, when the estimated point value is a range, the transacted point value may be a value in that range. In some embodiments, transaction ledger system 110 may execute and/or host an auction and/or bidding process to auction physical object 140. An online auction process may use point values as the bidding currency. Transaction ledger system 110 may identify the second user account as the winner of the online auction process with a winning bid being the transacted point value. In this case, the transacted point value may be the winning bid.

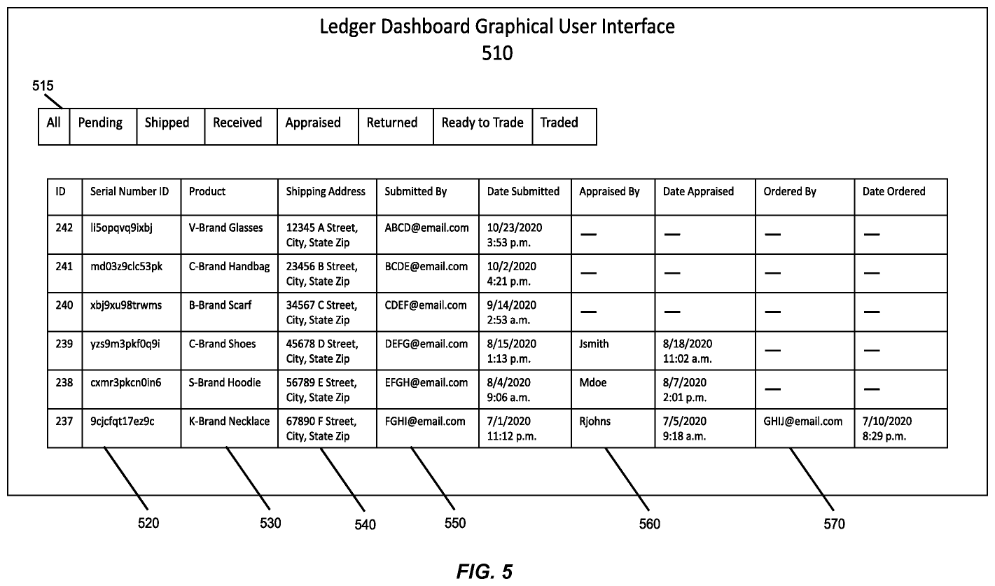

At 314, transaction ledger system 110 may generate a dashboard GUI with an authentication field for indicating authentication of the physical object. Examples of the dashboard GUI are further described with reference to FIGS. 4 and 5. The dashboard GUI is not limited solely to these embodiments and may instead be configured with different entry fields. In some embodiments, once a second user account has provide a transacted point value, the seller of physical object 140 may send physical object 140 to an administrator of transaction ledger system 110 for authentication. Upon authenticating physical object 140, the administrator may use the dashboard GUI to indicate that the physical object 140 has been authenticated.

At 316, transaction ledger system 110 may receive an indication of authentication completion via the dashboard GUI. For example, an administrator using transaction ledger system 110 and/or another user device 120 may access transaction ledger system 110 to provide the authentication completion. The administrator may submit status information. In some embodiments, the administrator may provide user identification and/or credentials identifying the administrator that performed the authentication. Transaction ledger system 110 may also record a timestamp corresponding to the received indication of authentication completion.

At 318, transaction ledger system 110 may update an authentication field of the token on the ledger to indicate authentication completion. Similar to the tokens described with reference to FIGS. 2A and 2B, transaction ledger system 110 may add information to the ledger in a hashed and/or block based format. The addition of this information may aid with immutability and/or may build a chain of data including the indication of authentication completion.

At 320, transaction ledger system 110 may determine a serial code ID corresponding to an RFID tag affixed to the physical object 140. As explained with reference to FIG. 1, if the RFID tag is preprogrammed with a serial code ID, transaction ledger system 110 may scan this serial code ID using RFID sensor 130. If the RFID tag is not preprogrammed, transaction ledger system 110 may assign a serial code ID to the RFID tag and/or burn this serial code ID into the RFID tag. Transaction ledger system 110 may determine the serial code ID before, after, or while an administrator affixes the RFID tag to physical object 140.

At 322, transaction ledger system 110 may update an RFID field of the token on the ledger with the serial code ID. This may preserve the serial code ID and associate the serial code ID to physical object 140.

At 324, transaction ledger system 110 may deduct the transacted point value from the second user account. For example, transaction ledger system 110 may deduct the points from a digital wallet of points corresponding to the second user account. At 326, transaction ledger system 110 may add the transacted point value to the first user account. Transaction ledger system 110 may add the points to a digital wallet of points corresponding to the first user account. At 328, transaction ledger system 110 may update the token on the ledger to record the transacted point value. This update may reflect the intrinsic value of physical object 140 and may associate the transacted point value to the intrinsic value.

At 330, transaction ledger system 110 may update the token on the ledger to associate the physical object 140 with the second user account and to disassociate the physical object 140 from the first user account. In some embodiments, the first user account and/or the second user account may view sold and/or purchased physical objects 140 via a GUI corresponding to the user account. An example of this GUI is further described with reference to FIG. 7.

At 332, method 300A may continue to method 300B to conduct a subsequent transaction.

FIG. 3B is a flowchart illustrating a computer-implemented method 300B for executing a second transaction, according to some embodiments. Method 300B shall be described with reference to FIGS. 1 and 3A; however, method 300B is not limited to that example embodiment.

In an embodiment, a transaction ledger system 110 may execute method 300B to facilitate a transaction between the second user account and a third user account. Method 300B describes a process for using transaction ledger system 110 to manage the transaction on a centralized ledger. In this way, transaction ledger system 110 may manage point values that are backed by the intrinsic value of physical object 140. While method 300B is described with reference to transaction ledger system 110, method 300B may be executed using any computing device, such as, for example, the computer system described with reference to FIG. 12 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 334, transaction ledger system 110 may continue from method 300A. Method 300B may be used to execute a transaction between a second user account and a third user account. Method 300B may also use the RFID tag scanned in method 300A.

At 336, transaction ledger system 110 may receive a second user interaction via a second GUI indicating a desire to sell the physical object 140. The second user interaction may correspond to the second user account. The second GUI may also be similar to the GUI described with reference to FIG. 6.

At 338, transaction ledger system 110 may generate a second webpage listing a sale of the physical object. The second webpage includes the transacted point value. In this embodiment, transaction ledger system 110 may generate a second webpage using the previously transacted point value to reflect the intrinsic value of the physical object 140. This may preserve the intrinsic value of physical object 140 if the condition has not changed. Similarly, using the previously transacted point value may avoid additional scraping or web crawling. In some embodiments, if an aspect of physical object 140 has changed, transaction ledger system 110 may use a different point value on the second webpage. This different point value may be a new estimate. Similarly, the different point value may be a range. At 340, transaction ledger system 110 may update the token on the ledger to indicate a listing of sale of the physical object 140.

At 342, transaction ledger system 110 may receive, via the second webpage, a request from a third user account to purchase the physical object 140 for a second transacted point value. Similar to the previous transacted point value, the second transacted point value may be the transacted point value listed on the second webpage and/or may be different. In some embodiments, transaction ledger system 110 may conduct an auction. The winning bid may be the second transacted point value. Upon determining the second transacted point value, transaction ledger system 110 may notify the second user account and may request that the corresponding user send physical object 140 to an administrator of transaction ledger system 110.

At 344, transaction ledger system 110 may scan the RFID tag affixed to the physical object 140 to determine a scanned serial code ID. Transaction ledger system 110 may perform this scan using RFID sensor 130. At 346, transaction ledger system 110 may compare the scanned serial code ID to the serial code ID associated with the token stored on the ledger. At 348, transaction ledger system 110 may determine that the scanned serial code ID matches the serial code ID associated with the token. This may verify that the physical object 140 is authentic. In some embodiments, this may allow an administrator to avoid additional authentication processes because physical object 140 has already been authenticated and tagged.

At 350, transaction ledger system 110 may deduct the second transacted point value from the third user account. At 352, transaction ledger system 110 may add the second transacted point value to the second user account. At 354, transaction ledger system 110 may update the token on the ledger to record the second transacted point value. At 356, transaction ledger system 110 may update the token on the ledger to associate the physical object 140 with the third user account and to disassociate the physical object 140 from the second user account. These processes may occur in a manner similar to those described with reference to FIG. 3A. In this manner, method 300B may provide a computer-implemented method for reselling physical object 140 from a second user account to a third user account.

In some embodiments, methods 200A, 200B, 300A and 300B may be combined. In some embodiments, steps and/or processes from these methods may be interchangeable. The processes may be executed using transaction ledger system 110.

FIG. 4 is a diagram that illustrates a graphical user interface (GUI) 410 for inputting transaction information, according to some embodiments. An administrator of transaction ledger system 110 may use GUI 410 to submit information to a centralized ledger. GUI 410 may include fields such as a serial number ID field 420, a product field 430, a status field 440, a submitted by field 450, an appraised by field 460, and/or an ordered by field 470. In some embodiments, GUI 410 may also include corresponding timestamp fields to track the completion of corresponding processes. In some embodiments, GUI 410 may also include one or more refund fields.

Serial number ID field 420 may be a field for tracking a serial code ID corresponding to an RFID tag. Transaction ledger system 110 may use RFID sensor 130 to scan a tag into the ledger. Upon scanning the RFID tag, transaction ledger system 110 may populate serial number ID field 420 to include the scanned serial code ID.

Product field 430 may include a description of physical object 140. Product field 430 may be populated when a user submits a listing to sell physical object 140. Transaction ledger system 110 may populate the product field 430 to include a name and/or identification of physical object 140 submitted by the user. For example, product field 430 may state “Brand-C Handbag” as an identifier.

Status field 440 may indicate a status of the transaction of physical object 140. For example, the status may reflect whether physical object 140 has been listed for sale, whether physical object 140 has been appraised, whether a buyer has completed a point transaction, whether an administrator has received physical object 140 from the seller, whether physical object 140 has been authenticated, whether physical object 140 has been packaged, whether physical object 140 has been shipped, whether physical object 140 has been delivered, and/or whether physical object 140 has been refunded.

Submitted by field 450 may indicate user identification and/or user credentials corresponding to the seller of physical object 140. For example, this may include a user name or screenname and/or other identifying information.

Appraised by field 460 may indicate user identification and/or user credentials corresponding to an appraiser of physical object 140. For example, this may include an administrator name or screenname and/or other identifying information. In some embodiments, if Internet scraping and/or crawling has been used, the appraisal may indicate that an estimated point value is based on the Internet data.

Ordered by field 470 may indicate user identification and/or user credentials corresponding to the buyer of physical object 140. For example, this may include a user name or screenname and/or other identifying information.

Upon populating one or more of these fields, transaction ledger system 110 may preserve the information on the ledger. In some embodiments, transaction ledger system 110 may populate one or more of these fields. In some embodiments, an administrator of transaction ledger system 110 may populate one or more of these fields.

FIG. 5 is a diagram that illustrates a graphical user interface (GUI) 510 of a ledger dashboard, according to some embodiments. An administrator may view GUI 510 to view ledger information managed by transaction ledger system 110. The administrator may access GUI 510 from transaction ledger system 110 and/or via a user device 120. GUI 510 may include tabs 515 for filtering ledger data based on a status corresponding to physical object 140. Selecting tabs 515 may filter different physical objects 140 having different statuses. These statuses may correspond to the status field 440 described with reference to FIG. 4.

GUI 510 may also include fields corresponding to the fields described with reference to FIG. 4. For example, GUI 510 may include a serial number ID field 520, a product field 530, a shipping address field 540, a submitted by field 550, an appraised by field 560, and/or an ordered by field 570. Selecting an entry in GUI 510 may also provide additional information related to the status of a physical object 140.

FIG. 6 is a diagram that illustrates a graphical user interface (GUI) 600 for managing user account information, according to some embodiments. Transaction ledger system 110 may generate GUI 600. A user may view GUI 600 using a user device 120 accessing transaction ledger system 110 via Internet 150. Using GUI 600, a user may navigate and/or view different account information. For example, the user may view and/or modify personal information, address book information, a wish list of products, a wallet point balance, payment methods, transactions, and/or membership plan. Using GUI 600, the user may also use button 610 to submit a listing as previously described.

FIG. 7 is a diagram that illustrates a graphical user interface (GUI) 700 for managing user transactions, according to some embodiments. A user may access GUI 700 using GUI 600. For example, selecting button 710 corresponding to transactions may display the transaction information on GUI 700. GUI 700 may display a listing 720 of physical objects 140 submitted for sale by the user. GUI 700 may also display a listing 730 of physical objects purchased by the user. Using GUI 700, users may track the statuses, point values, and/or purchase dates of their transactions.

FIG. 8 is a diagram that illustrates a graphical user interface (GUI) 800 for managing a user point balance, according to some embodiments. A user may access GUI 800 using GUI 600. For example, selecting button 810 corresponding to a point balance may display point balance information on GUI 800. GUI 800 may also include a point balance 820 displaying a point balance corresponding to the user's digital wallet. Using GUI 800, the user may also purchase additional points. In some embodiments, GUI 800 may allow a user to cash out points and/or to convert the points into a monetary currency. GUI 830 may also include a list 830 of transactions from previous purchases of points.

FIG. 9 is a diagram that illustrates a graphical user interface (GUI) 900 for browsing listed products, according to some embodiments. Transaction ledger system 110 may generate GUI 900. A user may view GUI 900 using a user device 120 accessing transaction ledger system 110 via Internet 150. Using GUI 900, a user may navigate and/or browse through different webpages listing different physical objects 140 for sale. GUI 900 may include GUI objects such as buttons, images, and/or point values 910 corresponding to the physical objects 140. Using GUI 900, users may see images as well as corresponding point values 910 to aid the user in evaluating whether to view the corresponding webpage. These webpages may be accessed by selecting a link button 920. Selecting the link button 920 may allow the user to access the webpage with the listing for a particular physical object 140.

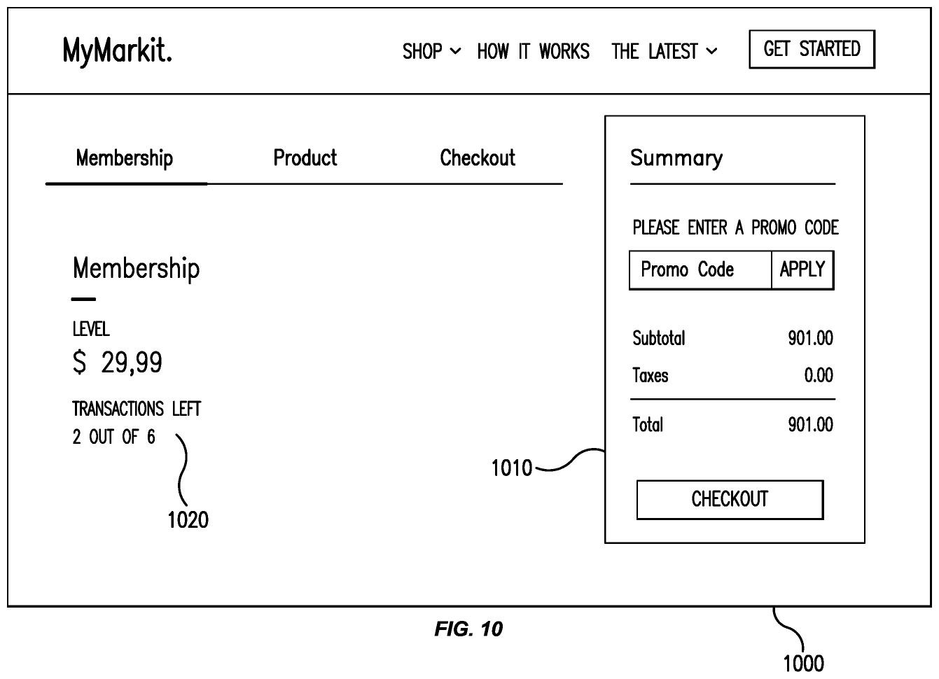

FIG. 10 is a diagram that illustrates a graphical user interface (GUI) 1000 for confirming membership transaction details, according to some embodiments. Transaction ledger system 110 may generate GUI 1000. A user may view GUI 1000 using a user device 120 accessing transaction ledger system 110 via Internet 150. In some embodiments, a user may view GUI 1000 during the process of purchasing physical object 140. As previously explained, transaction ledger system 110 may track membership information and/or a number of transactions corresponding to a user account. This number of transactions may aid with removing overhead and/or transactions costs from the point values exchanged for the physical object 140. In this way, transaction ledger system 110 may preserve the exchange based on the intrinsic value of physical object 140. When a buyer purchases physical object 140, the buyer may review GUI 1000 to determine a total amount of points 1010 to complete the transaction. The buyer may also review GUI 1000 to determine a remaining balance of transactions 1020 corresponding to the user account. This remaining balance may correspond to a membership tier purchased by the user.

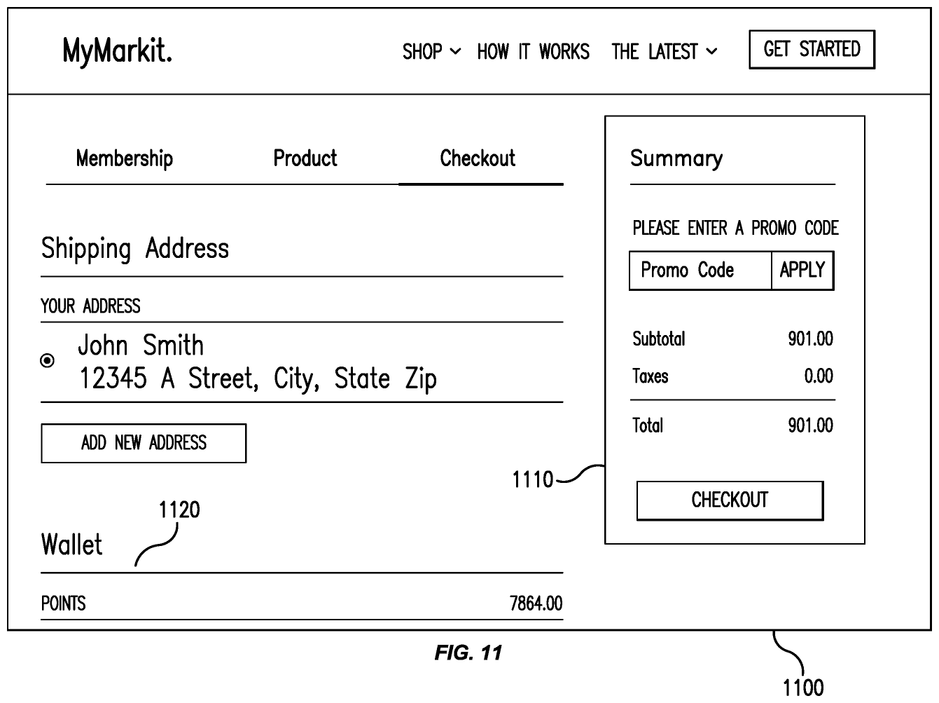

FIG. 11 is a diagram that illustrates a graphical user interface (GUI) 1100 for confirming a transaction, according to some embodiments. Transaction ledger system 110 may generate GUI 1100. A user may view GUI 1100 using a user device 120 accessing transaction ledger system 110 via Internet 150. In some embodiments, a user may view GUI 1100 during the process of purchasing physical object 140. GUI 1100 may include a checkout button 1110 and/or a point balance 1120. GUI 1100 may also provide a display for confirming the correct shipping address for receiving physical object 140. Using GUI 1100, a buyer may complete a transaction and purchase physical object 140.

Various embodiments may be implemented, for example, using one or more well-known computer systems, such as computer system 1200 shown in FIG. 12. One or more computer systems 1200 may be used, for example, to implement any of the embodiments discussed herein, as well as combinations and sub-combinations thereof.

Computer system 1200 may include one or more processors (also called central processing units, or CPUs), such as a processor 1204. Processor 1204 may be connected to a communication infrastructure or bus 1206.

Computer system 1200 may also include user input/output device(s) 1203, such as monitors, keyboards, pointing devices, etc., which may communicate with communication infrastructure 1206 through user input/output interface(s) 1202.

One or more of processors 1204 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for tracking authentication of physical objects using a ledger, the method comprising:
generating a token corresponding to a physical object, wherein the token includes an authentication field and a sensor field;
generating a dashboard graphical user interface (GUI) with an authentication GUI object for indicating authentication of the physical object;
receiving an indication of authentication completion via the authentication GUI object;
updating the authentication field of the token to indicate authentication of the physical object;
determining, via the dashboard GUI, a serial code identification (ID) corresponding to a sensor tag affixed to the physical object;
updating the sensor field of the token to include the serial code ID; and
storing the token on the ledger to preserve the authentication of the physical object with the corresponding serial code ID.

2. The method of claim 1, wherein the sensor tag is a radio frequency identification (RFID) tag and wherein the serial code ID is a RFID value corresponding to the RFID tag.

3. The method of claim 1, wherein the ledger is a blockchain ledger and the token is a non-fungible token (NFT).

4. The method of claim 1, further comprising:
receiving, via a second GUI dashboard, a request to authenticate the physical object;
scanning the sensor tag affixed to the physical object to determine a scanned serial code ID;
comparing the scanned serial code ID to the serial code ID stored on the ledger;
determining that the scanned serial code ID matches the serial code ID stored on the ledger; and
in response to the determining, generating an indication on the second GUI dashboard that the physical object has been authenticated.

5. The method of claim 4, wherein the ledger is used to conduct a transaction to exchange a physical object between a first and second individual, wherein the token is recorded on the ledger in an entry corresponding to the first individual, wherein the determination that the scanned serial code ID matches the serial code ID verifies authenticity of the physical object, wherein the method further comprises:
deducting, from a second point value on the ledger, a number of points corresponding to the intrinsic value of the physical object, the second point value representing points belonging to the second individual;
adding, to a first point value on the ledger, the number of points, the first point value representing points belonging to the first individual;
updating the ledger to associate the token with the second individual and disassociate the token from the first individual; and
transferring possession of the physical object from the first individual and to the second individual,
whereby the token, by updating association in accordance with possession of the physical object, backs the number of points deducted and added on the ledger with the intrinsic value of the physical object.

6. The method of claim 5, wherein the transaction is a first transaction and the method further comprises, to conduct a second transaction to exchange the physical object between the second individual and a third individual:
determining a second number of points based on a new intrinsic value of the physical object;
scanning the physical object to read a signal from the sensor tag;
comparing the read signal with the serial number in the ledger to verify authenticity of the physical object;
when the physical object is verified as authentic:
deducting, from a third point value on the ledger, the second number of points corresponding to the intrinsic value of the physical object, the third point value representing points belonging to the third individual;
adding, to the second point value on the ledger, the second number of points;
updating the ledger to associate the token with the third individual and disassociate the token from the second individual; and
transferring possession of the physical object from the second individual and to the third individual.

7. The method of claim 5, further comprising:
determining the number of points corresponding to the intrinsic value of the physical object using an expert appraisal.

8. The method of claim 5, further comprising:
determining the number of points corresponding to the intrinsic value of the physical object using an auction bidding process.

9. The method of claim 5, further comprising:
exchanging at least some of the first or second point value on the ledger for cash.

10. A computer implemented method for managing a ledger to conduct a transaction to exchange a physical object, the computer implemented method comprising:
receiving a user interaction via a graphical user interface (GUI) indicating a desire to sell the physical object, wherein the user interaction corresponds to a first user account;
receiving, via the GUI, identifying data corresponding to the physical object;
generating a webpage listing a sale of the physical object, wherein the webpage includes an estimated point value for the physical object based on the identifying data and shopping data scraped from other Internet webpages;
generating a token corresponding to the physical object;
recording the token on the ledger;
receiving, via the webpage, a request from a second user account to purchase the physical object for a transacted point value;
generating a dashboard GUI with an authentication field for indicating authentication of the physical object;
receiving an indication of authentication completion via the dashboard GUI;
updating an authentication field of the token on the ledger to indicate authentication completion;
determining a serial code identification (ID) corresponding to a sensor tag affixed to the physical object;
updating a sensor field of the token on the ledger with the serial code ID;
deducting the transacted point value from the second user account;
adding the transacted point value to the first user account;
updating the token on the ledger to record the transacted point value; and
updating the token on the ledger to associate the physical object with the second user account and to disassociate the physical object from the first user account.

11. The computer implemented method of claim 10, further comprising:
receiving a second user interaction via a second GUI indicating a desire to sell the physical object, wherein the second user interaction corresponds to a second user account;
generating a second webpage listing a sale of the physical object, wherein the second webpage includes the transacted point value; and
updating the token on the ledger to indicate a listing of sale of the physical object.

12. The computer implemented method of claim 11, further comprising:
receiving, via the second webpage, a request from a third user account to purchase the physical object for a second transacted point value;
scanning the sensor tag affixed to the physical object to determine a scanned serial code ID;
comparing the scanned serial code ID to the serial code ID associated with the token stored on the ledger;
determining that the scanned serial code ID matches the serial code ID associated with the token;
deducting the second transacted point value from the third user account;
adding the second transacted point value to the second user account;
updating the token on the ledger to record the second transacted point value; and
updating the token on the ledger to associate the physical object with the third user account and to disassociate the physical object from the second user account.

13. The computer implemented method of claim 10, wherein the estimated point value is a range of values and the transacted point value is a value within the range.

14. The computer implemented method of claim 10, wherein receiving the request from the second user account to purchase the physical object further comprises:
hosting an online auction process using point values as bidding currency; and
identifying the second user account as winner of the online auction process with a winning bid of the transacted point value.

15. The computer implemented method of claim 10, further comprising:
managing a total number of transactions corresponding to the second user account; and
deducting a transaction from the total number of transactions when deducting the transacted point value from the second user account.

16. The computer implemented method of claim 10, further comprising:
converting an amount of points corresponding to the first user account to a monetary currency value for withdrawal.

17. A transaction ledger system for managing a ledger to conduct a transaction to exchange a physical object, comprising:
a memory; and
at least one processor coupled to the memory and configured to:
receive a user interaction via a graphical user interface (GUI) indicating a desire to sell the physical object, wherein the user interaction corresponds to a first user account;
receive, via the GUI, identifying data corresponding to the physical object;
generate a webpage listing a sale of the physical object, wherein the webpage includes an estimated point value for the physical object based on the identifying data and shopping data scraped from other Internet webpages;
generate a token corresponding to the physical object;
record the token on the ledger;
receive, via the webpage, a request from a second user account to purchase the physical object for a transacted point value;
generate a dashboard GUI with an authentication field for indicating authentication of the physical object;
receive an indication of authentication completion via the dashboard GUI;
update an authentication field of the token on the ledger to indicate authentication completion;
determine a serial code identification (ID) corresponding to a radio frequency identification (RFID) tag affixed to the physical object;
update a RFID field of the token on the ledger with the serial code ID;
deduct the transacted point value from the second user account;
add the transacted point value to the first user account;
update the token on the ledger to record the transacted point value; and
update the token on the ledger to associate the physical object with the second user account and to disassociate the physical object from the first user account.

18. The transaction ledger system of claim 17, wherein the at least one processor is further configured to:
receive a second user interaction via a second GUI indicating a desire to sell the physical object, wherein the second user interaction corresponds to a second user account;
generate a second webpage listing a sale of the physical object, wherein the second webpage includes the transacted point value; and
update the token on the ledger to indicate a listing of sale of the physical object.

19. The transaction ledger system of claim 18, wherein the at least one processor is further configured to:
receive, via the second webpage, a request from a third user account to purchase the physical object for a second transacted point value;
scan the sensor tag affixed to the physical object to determine a scanned serial code ID;
compare the scanned serial code ID to the serial code ID associated with the token stored on the ledger;
determine that the scanned serial code ID matches the serial code ID associated with the token;
deduct the second transacted point value from the third user account;
add the second transacted point value to the second user account;
update the token on the ledger to record the second transacted point value; and
update the token on the ledger to associate the physical object with the third user account and to disassociate the physical object from the second user account.

20. The transaction ledger system of claim 17, wherein the estimated point value is a range of values and the transacted point value is a value within the range.

21. The transaction ledger system of claim 17, wherein to receive the request from the second user account to purchase the physical object, the at least one processor is further configured to:
host an online auction process using point values as bidding currency; and
identify the second user account as winner of the online auction process with a winning bid of the transacted point value.

22. The transaction ledger system of claim 17, wherein the at least one processor is further configured to:
manage a total number of transactions corresponding to the second user account; and
deduct a transaction from the total number of transactions when deducting the transacted point value from the second user account.

23. The transaction ledger system of claim 17, wherein the at least one processor is further configured to:
convert an amount of points corresponding to the first user account to a monetary currency value for withdrawal.
